(19) United States
(12) Patent Application Publication
(10) Pub. No.: US 2016/0288207 A1
(43) Pub. Date: Oct. 6, 2016

(54) DIRECT METAL LASER SINTERING MACHINE

(71) Applicant: United Technologies Corporation, Hartford, CT (US)

(72) Inventor: David Evan Gambardella, East Haven, CT (US)

(21) Appl. No.: 14/679,190

(22) Filed: Apr. 6, 2015

(51) Int. Cl. B22F 3/105

(52) U.S. Cl. CPC B22F 3/1055; B22F 2003/1057; B33Y 10/00

(57) ABSTRACT

An additive manufacturing apparatus includes a print bed. An arm rotates about a central axis concentric with the print bed. A print head is positioned on the arm. The print head is configured to move relative to the print bed along a cylindrical coordinate system including a z-coordinate, r-coordinate, and a φ-coordinate. A deposition nozzle is disposed on the print head. The deposition nozzle is configured to deposit powdered material onto the print bed. A laser head is disposed on the print head and includes a laser.

### BACKGROUND

The present invention relates to additive manufacturing machines, and in particular, to forming a part using an additive manufacturing machine.

Additive manufacturing is an established but growing technology. In its broadest definition, additive manufacturing is any layerwise construction of articles from thin layers of feed material. Additive manufacturing may involve applying liquid, layer, or particle material to a workstage, then sintering, curing, melting, and/or cutting to create a layer. The process is repeated up to several thousand times to construct the desired finished component or article.

### SUMMARY

An additive manufacturing apparatus includes a print bed. An arm rotates about a central axis concentric with the print bed. A print head is positioned on the arm. The print head is configured to move relative to the print bed along a cylindrical coordinate system including a z-coordinate, r-coordinate, and a φ-coordinate. A deposition nozzle is disposed on the print head. The deposition nozzle is configured to deposit powdered material onto the print bed. A laser head is disposed on the print head and includes a laser.

A method of additive manufacturing includes generating data defining a part to be built in an additive manufacturing apparatus. A print head is positioned at a starting point above a print bed. The print head includes a nozzle and a laser head. The print head is positioned on an arm. A first powdered material is deposited at a first location from a central axis of the print bed. A directed energy source is used to selectively melt or sinter the first powdered material. The directed energy source is delivered by the laser head. The print head is moved relative to the print bed in a radial direction from the central axis of the print bed along a cylindrical coordinate system including a z-coordinate, r-coordinate, and a φ-coordinate. The z-coordinate defines a vertical distance between the print bed and the print head. The r-coordinate defines a radial distance between the print head and the axis of rotation. The φ-coordinate defines a degree of rotation between the arm and a defined rotational starting point. Additional powdered material is deposited at locations other than the first location. The directed energy source is used to selectively melt or sinter the additional powdered material. The arm is rotated. The previous steps are repeated as necessary in accordance with the data. The z-coordinate is adjusted. The previous steps are repeated as necessary in accordance with the data. The part is then completed.

A method of additive manufacturing includes generating data defining a part to be built in a direct metal laser sintering. A vertical distance between the print bed and print head, a radial distance between the print head and an axis of rotation, and a degree of rotation between an arm and a defined rotational starting point are controlled. The vertical distance, radial distance, and the degree of rotation are defined by a cylindrical coordinate system including a z-coordinate, r-coordinate, and a φ-coordinate. The z-coordinate defines the vertical distance between the print bed and the print head, the r-coordinate defines the radial distance between the print head and the axis of rotation, and the φ-coordinate defines the degree of rotation between the arm and the defined rotational starting point. A print head is positioned at a starting point above a print bed. The print head includes a nozzle and a laser head. The print head is positioned on the arm. A first powdered material is deposited at a first location from a central axis of the print bed. A directed energy source is used to selectively melt or sinter the first powdered material. The directed energy source is delivered by the laser head. The r-coordinate is adjusted. Additional powdered material is deposited at locations other than the first location. The directed energy source is used to selectively melt or sinter the additional powdered material. The arm is rotated. The previous steps are repeated as necessary in accordance with the data. The z-coordinate is adjusted. The previous steps are repeated as necessary in accordance with the data. The part is then completed.

### BRIEF DESCRIPTION OF THE DRAWINGS

FIG. 1 is a top view of a prior art DMLS additive manufacturing machine.

FIG. 2A is a perspective view of a DMLS additive manufacturing machine.

FIG. 2B is a perspective view of a DMLS additive manufacturing machine.

FIG. 3 is a flow chart of an additive manufacturing method.

FIG. 4 is a flow chart of an additive manufacturing method.

### DETAILED DESCRIPTION

Additive manufacturing machines, and in particular, Direct Metal Laser Sintering (“DMLS”) machines are becoming increasingly popular for a number of reasons including: reduced waste material, decreased lead time, ease of producing low quantity complex parts, and the ability to create internal structures that no other manufacturing process can produce.

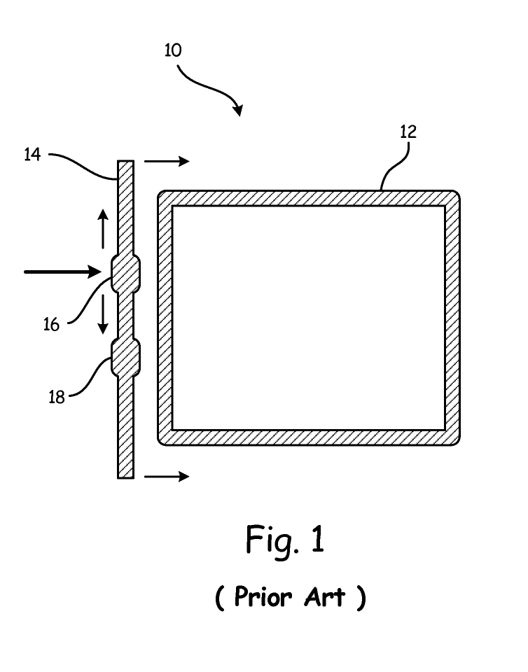

FIG. 1 is a top view of prior art DMLS additive manufacturing machine 10. Prior art DMLS additive manufacturing machine 10 includes print bed 12, translation arm 14, laser head 16, and print head 18. Translation arm 14 is attached to print bed 12. Translation arm 14 is configured to move across print bed 12 with a linear movement. Laser head 16 and print head 18 move along translation arm 14. Movement of laser head 16 and print head 18 can be controlled by data from a Computer-Aided Design (“CAD”) model defining the dimensions of a part to be built by prior art DMLS additive manufacturing machine 10.

During the build of a part, print head 18 deposits powdered material in a location designated by data from the CAD model. After the powdered material is deposited, laser head 16 emits a laser beam at the powdered material to melt or sinter the powdered material. After the laser beam has melted or sintered the powdered material, a solid layer of material is formed. This process is continued along the design of the part until the part is completely formed of solid material.

Generally, print beds for additive manufacturing machines are relatively small. In particular, print beds for DMLS machines are typically 1′×1′×1.5′ or smaller, and as a result parts of a relatively small size can be produced. It is also a general principle of using DMLS machines to maximize the amount of the part being printed at one time. As a result, large cylindrical or ring shaped parts are difficult to produce in DMLS machines.

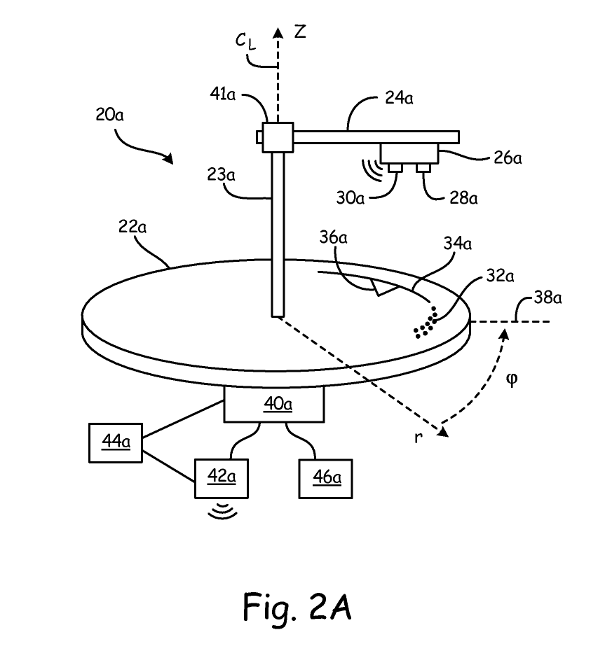

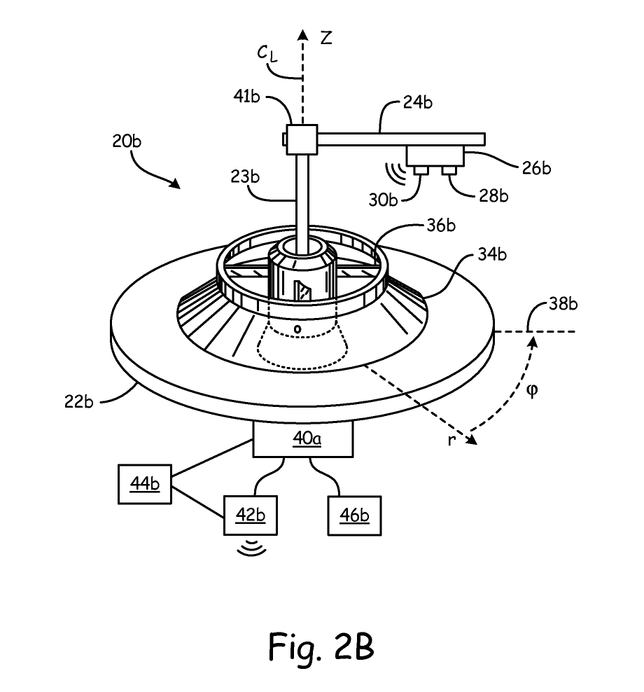

FIG. 2A is a perspective view of DMLS additive manufacturing machine 20a. DMLS additive manufacturing machine 20a includes print bed 22a, shaft 23a, arm 24a, and print head 26a. Print bed 22a includes a circular disk or ring shape, but in other embodiments the shape of print bed 22a may include other non-circular shapes such as a square or rectangle.

Print bed 22a is attached to shaft 23a such that shaft 23a is configured to rotate about central axis C_{L} concentric with print bed 22a. Shaft 23a is also configured to translate along central axis C_{L} of print bed 22a. Print head 26a is attached to arm 24a and is able to move back and forth along arm 24a.

Print head 26a includes deposition nozzle 28a and laser head 30a. Deposition nozzle 28a is configured to deposit powdered material 32a onto print bed in accordance with data defining part 34a to be built in DMLS additive manufacturing machine 20a. During operation of DMLS additive manufacturing machine 20a, laser head 30a uses a directed energy source to selectively melt or sinter powdered material 32a. The directed energy source may include a laser or other high energy emission. Print head 26a also includes an actuator or motor that moves print head along arm 24a. Powdered material 32a may include powdered metal such as Inconel, aluminum, steel, or other types of alloy metals. Powdered material 32a may also include non-metal powders such as plastic, ceramics, or other non-metal compounds.

Part 34a may include a generally cylindrical, annular, or ring shape. Part 34a may also include internal support structure 36a designed in accordance with the data defining part 34a. Depending on the application, internal support structure 36a can be designed to provide optimum performance characteristics for various aerospace environments including varying stress loads, thermodynamic ranges, frequency rates, etc.

Print head 26a is configured to move relative to print bed 22a along a cylindrical coordinate system including a z-coordinate, r-coordinate, and φ-coordinate. The z-coordinate defines a vertical distance between print bed 22a and print head 26a. The z-coordinate extends along central axis C_{L}. The origin of the z-coordinate is positioned at the intersection of axis C_{L} with a printing surface of print bed 22a. The r-coordinate defines a radial distance between print head 26a and central axis C_{L}. The φ-coordinate defines a degree of rotation between arm 24a and rotational starting point 38a. Each of the z-coordinate, r-coordinate, and φ-coordinate are controlled by the data defining part 34a.

Being able to produce cylindrical and/or ring shaped parts in DMLS additive manufacturing machine 20a provides many benefits not present in non-additive manufactured parts. Additively manufacturing cylindrical and/or ring shaped parts provide the benefits of improved build rates, decreased component costs, smaller manufacturing tolerances, lighter weight, internal channeling, internal support structures, and other various benefits available with additive manufacturing.

DMLS additive manufacturing machine 20a additionally includes motor 40a, actuator 41a, controller 42a, power source 44a, and powder delivery system 46a. Shaft 23a extends through print bed 22a to physically connect to motor 40a. Motor 40a controls the rotation of shaft 23a relative to print bed 22a. Motor 40a also causes the increase or decrease in vertical distance between print bed 22a and print head 26a by moving shaft 23a along the z-coordinate extending along central axis C_{L}. Motor 40a may cause shaft 23a to move along the z-coordinate relative to print bed 22a. Motor 40a may alternatively cause print bed 22a to move along the z-coordinate relative to shaft 23a. Additionally, the vertical distance between print bed 22a and arm 24a may be increased or decreased by actuator 41a which is configured to move arm 24a along the z-coordinate relative to shaft 23a.

Motor 40a is controlled by controller 42a. Controller 42a can control motor 40a through an electronic communication with a wire or through a wireless signal received by print head 26a. Both motor 40a and controller 42a are powered by power source 44a. Power source 44a also provides power to print head 26a and laser head 30a. Powder delivery system 46a provides powdered material to DMLS additive manufacturing machine 20a needed to construct part 34a as per the data.

FIG. 2B is a perspective view of DMLS additive manufacturing machine 20b. DMLS additive manufacturing machine 20b includes print bed 22b, shaft 23b, arm 24b, and print head 26b. Print bed 22b is attached to arm 24b such that arm 24b is configured to rotate about central axis C_{L} concentric with print bed 22b. Arm 24b is also configured to translate along central axis C_{L} of print bed 22b. Print head 26b is attached to arm 24b and is able to move back and forth along arm 24b.

Print head 26b includes deposition nozzle 28b and laser head 30b. Deposition nozzle 28b is configured to deposit a powdered material onto print bed in accordance with data defining part 34b to be built in DMLS additive manufacturing machine 20b. During operation of DMLS additive manufacturing machine 20b, laser head 30b uses a directed energy source to selectively melt or sinter the powdered material to form part 34b. Print head 26b also includes an actuator or motor that moves print head along arm 24b.

Part 34b includes a frusto-conical shaped case. Part 34b also includes internal support structure 36b designed in accordance with the data defining part 34b to provide optimum performance characteristics for various aerospace environments including varying stress loads, thermodynamic ranges, frequency rates, etc. Part 34b can also include holes, apertures, channels, conduits, compartments, structural supports, and other complex features that are configured for fluid management, attachment, containment, housing, support, and/or other additional functional aspects.

Print head 26b is configured to move relative to print bed 22b along a cylindrical coordinate system including a z-coordinate, r-coordinate, and φ-coordinate. The z-coordinate defines a vertical distance between print bed 22b and print head 26b. The z-coordinate extends along central axis C_{L}. The origin of the z-coordinate is positioned at the intersection of axis C_{L} with a printing surface of print bed 22b. The r-coordinate defines a radial distance between print head 26b and central axis C_{L}. The φ-coordinate defines a degree of rotation between arm 24b and rotational starting point 38b. Each of the z-coordinate, r-coordinate, and φ-coordinate are controlled by the data defining part 34b.

DMLS additive manufacturing machine 20b additionally includes motor 40b, actuator 41b, controller 42b, power source 44b, and powder delivery system 46b. Motor 40b controls the rotation of arm 24b relative to print bed 22b. Motor 40b also causes the increase or decrease in vertical distance between print bed 22b and print head 26b by moving shaft 23b along the z-coordinate extending along central axis C_{L}. Motor 40b may cause shaft 23b to move along the z-coordinate relative to print bed 22b. Motor 40b may alternatively cause print bed 22b to move along the z-coordinate relative to shaft 23b. Additionally, the vertical distance between print bed 22b and arm 24b may be increased or decreased by actuator 41b which is configured to move arm 24b along the z-coordinate relative to shaft 23b.

Motor 40b is controlled by controller 42b. Controller 42b can control motor 40b through an electronic communication with a wire or through a wireless signal received by print head 26b. Both motor 40b and controller 42b are powered by power source 44b. Power source 44b also provides power to print head 26b and laser head 30b. Powder delivery system 46b provides powdered material to DMLS additive manufacturing machine 20b needed to construct part 34b as per the data.

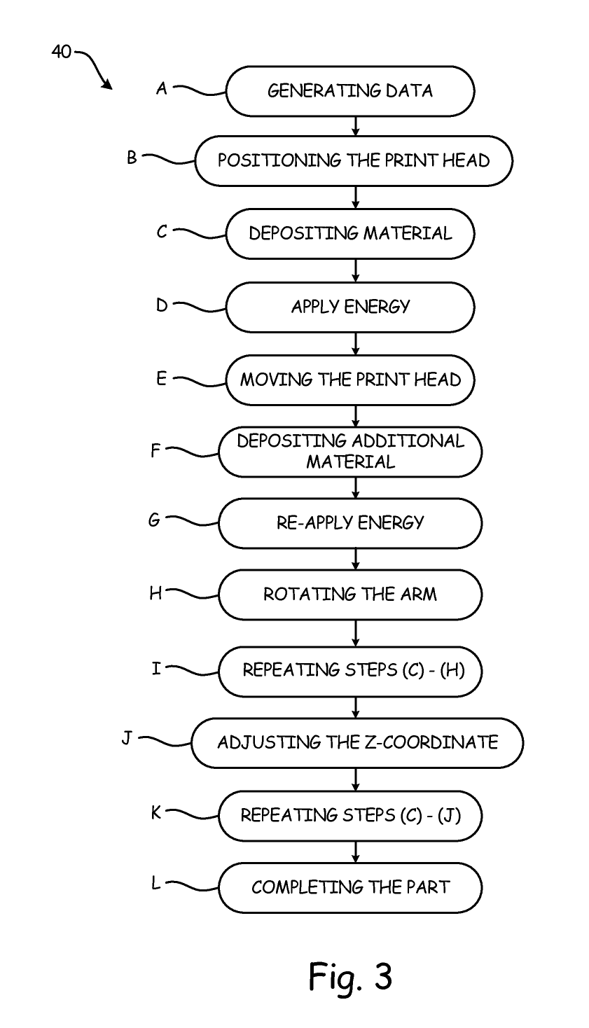

FIG. 3 is a flow chart of additive manufacturing method 48. Additive manufacturing method 40 includes steps A-L. Step A includes generating data defining a part to be built in an additive manufacturing apparatus. Generating the data can be completed through creating CAD models and/or blueprint models. The CAD or blueprint models are then converted into a digital file which includes electronic instructions for the additive manufacturing apparatus. The data also includes an optimized build pattern that enables the most efficient production of a part. The efficient production of the part can include minimizing the build time, material waste, power, and other important production resources.

Step B includes positioning a print head at a starting point above a print bed. The specific location of the print head is determined by the data from the CAD or blueprint models. The print head includes a deposition nozzle and a laser head. The print head is positioned on an arm.

Step C includes depositing a first powdered material at a first location from a central axis of the print bed. The location and amount of powder deposition is controlled by the data from the CAD or blueprint models. Step D includes using a directed energy source to selectively melt or sinter the first powdered material. The directed energy source is delivered by the laser head and may include a laser beam. Other directed energy sources may include electro-magnetic or mechanical wave sources such as ultraviolet, visible light, infrared, or acoustical curing methods.

Step E includes moving the print head relative to the print bed in a radial direction from the central axis of the print bed along a cylindrical coordinate system including a z-coordinate, r-coordinate, and a φ-coordinate. The z-coordinate defines a vertical distance between the print bed and the print head, the r-coordinate defines a radial distance between the print head and the axis of rotation, and the φ-coordinate defines a degree of rotation between the arm and a defined rotational starting point.

Step F includes depositing additional powdered material at locations other than the first location. The locations other than the first location may include extensions of the part such as internal support structures connected to the material from the first location. The locations other than the first location may also include locations defining an adjacent feature not connected to the first location by material. This location could define an exterior layer of the part or an additional support structure of the part. Alternatively, the locations other than the first location may be used to create conduits, channels, or piping within or externally connected to the part, for example an engine case for a turbine engine.

Step G includes using the directed energy source to selectively melt or sinter the additional powdered material. Step H includes rotating the arm to move the print head to a new deposition location. Step I includes repeating steps C-H as necessary in accordance with the electronic instructions from the CAD or blueprint model data. Step J includes adjusting the z-coordinate to move the print head to a new deposition altitude relative to the print bed. Step K includes repeating steps C-J as necessary in accordance with the electronic instructions from the CAD or blueprint model data.

Step L includes completing the part. Completing the part may include hardening the last powdered material in order to form a complete part as per the electronic instructions from the CAD or blueprint model data. Completing the part may also include finishing steps such as deburring, peening, coating or film applications, and other surface treatment applications.

Additive manufacturing method 48 provides advantages over prior art methods of additive manufacturing because smaller amounts of time between deposition iterations are needed as compared to prior art side-to-side deposition methods. The rotational and radial degrees of freedom allow for a smaller amount of time between deposition iterations because the print head only needs to move a single circular iteration to deposit material in a new location as opposed to a prior art method which would require the print head move in both an X and a Y direction before relocating at a new deposition location. This capability is specifically beneficial for cylindrical or conical parts because over the entire build process, a lot of time is saved for parts requiring many layers of material.

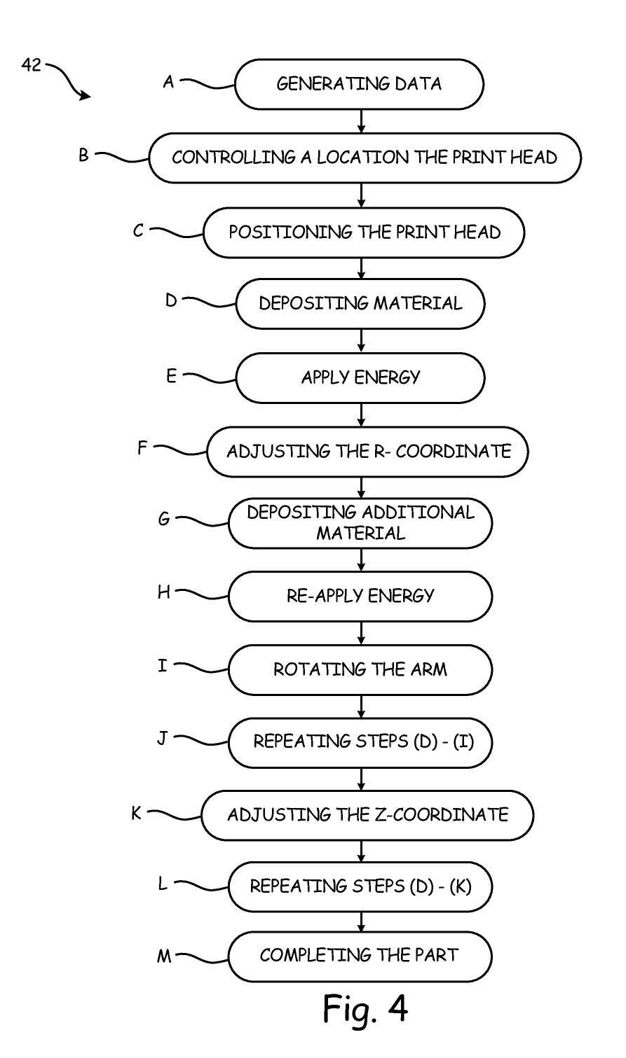

FIG. 4 is a flow chart of additive manufacturing method 50. Additive manufacturing method 50 includes steps A-M. Step A includes generating data defining a part to be built in an additive manufacturing apparatus. Generating the data can be done through creating CAD models and/or blueprint models. The CAD or blueprint models are then converted into a digital file which includes electronic instructions for the additive manufacturing apparatus. The data also includes an optimized build pattern that enables the most efficient production of a part. The efficient production of the part can include minimizing the build time, material waste, power, and other important production resources.

Step B includes controlling a vertical distance between a print bed and a print head, a radial distance between the print head and an axis of rotation, and a degree of rotation between an arm and a defined rotational starting point. The vertical distance, radial distance, and the degree of rotation are defined by a cylindrical coordinate system including a z-coordinate, r-coordinate, and a φ-coordinate. The z-coordinate defines the vertical distance between the print bed and the print head, the r-coordinate defines the radial distance between the print head and the axis of rotation, and the φ-coordinate defines the degree of rotation between the rotating arm and the defined rotational starting point. The positioning of the print head is controlled by a controller of the additive manufacturing apparatus in electronic or wireless communication with the print head.

Step C includes positioning the print head at a starting point above the print bed. The specific location of the print head is determined by the data from the CAD or blueprint models. The print head includes a deposition nozzle and a laser head. The specific location of the print head is determined by the data from the CAD or blueprint models. The print head is positioned on an arm.

Step D includes depositing a first powdered material at a first location from a central axis of the print bed. The location and amount of powder deposition is controlled by the data from the CAD or blueprint models. Step E includes using a directed energy source to selectively melt or sinter the first powdered material. The directed energy source is delivered by the laser head and may include a laser beam. Other directed energy sources may include electro-magnetic or mechanical wave sources such as ultraviolet, visible light, infrared, or acoustical curing methods. Step F includes adjusting the r-coordinate of the print head by moving the print head away from or closer to the center axis C_{L} along the arm.

Step G includes depositing additional powdered material at locations other than the first location. The locations other than the first location may include extensions of the part such as internal support structures connected to the material from the first location. The locations other than the first location may also include locations defining an adjacent feature not connected to the first location by material. This location could define an exterior layer of the part or an additional support structure of the part. Alternatively, the locations other than the first location may be used to create conduits, channels, or piping within or externally connected to the part, for example an engine case for a turbine engine.

Step H includes using the directed energy source to selectively melt or sinter the additional powdered material. Step I includes rotating the arm to move the print head to a new deposition location. Step J includes repeating steps D-I as necessary in accordance with the data. Step K includes adjusting the z-coordinate. Step L includes repeating steps D-K as necessary in accordance with the data.

Step M includes completing the part. Completing the part may include hardening the last powdered material in order to form a complete part as per the electronic instructions from the CAD or blueprint model data. Completing the part may also include finishing steps such as deburring, peening, coating or film applications, and other surface treatment applications.

### Discussion of Possible Embodiments

The following are non-exclusive descriptions of possible embodiments of the present invention.

An additive manufacturing apparatus may include a print bed and an arm. The arm may rotate about a central axis concentric with the print bed. A print head may be positioned on the arm. The print head may be configured to move relative to the print bed along a cylindrical coordinate system which may include a z-coordinate, r-coordinate, and a φ-coordinate. A deposition nozzle may be disposed on the print head. The deposition nozzle may be configured to deposit powdered material onto the print bed. A laser head may be disposed on the print head. The laser head may include a laser.

The additive manufacturing apparatus of the preceding paragraph can optionally include, additionally and/or alternatively, any one or more of the following features, configurations and/or additional components:

a further embodiment of the foregoing additive manufacturing apparatus, wherein the additive manufacturing apparatus may include a direct metal laser sintering machine;

a further embodiment of the foregoing additive manufacturing apparatus, wherein the print bed may include a circular disk shape;

a further embodiment of the foregoing additive manufacturing apparatus, wherein the z-coordinate may define a vertical distance between the print bed and the print head, the r-coordinate may define a radial distance between the print head and the axis of rotation, and the φ-coordinate may define a degree of rotation between the arm and a defined rotational starting point;

a further embodiment of the foregoing additive manufacturing apparatus, wherein the material may include a powdered metal;

a further embodiment of the foregoing additive manufacturing apparatus, wherein the print bed may include a ring shape;

a further embodiment of the foregoing additive manufacturing apparatus, wherein the additive manufacturing apparatus may be configured to control the vertical distance between the print bed and the print head;

a further embodiment of the foregoing additive manufacturing apparatus, wherein the vertical distance between the print bed and the print head may be controlled by at least one of a first motor or a first actuator;

a further embodiment of the foregoing additive manufacturing apparatus, wherein the additive manufacturing apparatus may be configured to control the radial distance between the print head and the axis of rotation;

a further embodiment of the foregoing additive manufacturing apparatus, wherein the radial distance between the print head and the axis of rotation may be controlled by at least one of a second motor or a second actuator;

a further embodiment of the foregoing additive manufacturing apparatus, wherein the additive manufacturing apparatus may be configured to control the degree of rotation between the arm and the defined rotational starting point; and

a further embodiment of the foregoing additive manufacturing apparatus, wherein the degree of rotation between the arm and the defined rotational starting point may be controlled by at least one of a first motor or a first actuator.

An additive manufacturing method may include generating data defining a part to be built in an additive manufacturing apparatus. A print head may be positioned at a starting point above a print bed. The print head may include a deposition nozzle and a laser head. The print head may be positioned on an arm. A first powdered material may be deposited at a first location from a central axis of the print bed. A directed energy source may be used to selectively melt or sinter the first powdered material. The directed energy source may be delivered by the laser head. The print head may be moved relative to the print bed in a radial direction from the central axis of the print bed along a cylindrical coordinate system including a z-coordinate, r-coordinate, and a φ-coordinate. The z-coordinate may define a vertical distance between the print bed and the print head. The r-coordinate may define a radial distance between the print head and the axis of rotation. The φ-coordinate may define a degree of rotation between the arm and a defined rotational starting point. Additional powdered material may be deposited at locations other than the first location. The directed energy source may be used to selectively melt or sinter the additional powdered material. The arm may be rotated. The previous steps may be repeated as necessary in accordance with the data. The z-coordinate may be adjusted. The previous steps may be repeated as necessary in accordance with the data. The part may then be completed.

The additive manufacturing method of the preceding paragraph can optionally include, additionally and/or alternatively, any one or more of the following features, configurations and/or additional components:

a further embodiment of the foregoing additive manufacturing method, wherein the method may further include building the part with at least a portion of the part including a cylindrical or ring shape;

a further embodiment of the foregoing additive manufacturing method, wherein the method may further include controlling the vertical distance between the print bed and the print head;

a further embodiment of the foregoing additive manufacturing method, wherein the method may further include controlling the radial distance between the print head and the axis of rotation;

a further embodiment of the foregoing additive manufacturing method, wherein the method may further include controlling the degree of rotation between the arm and the defined rotational starting point;

a further embodiment of the foregoing additive manufacturing method, wherein the method may further include constructing an internal support structure formed onto the part; and

a further embodiment of the foregoing additive manufacturing method, wherein moving the print head may include following the data defining the part to guide the print head's motion and deposition of the first and additional powdered material.

A method of additive manufacturing may include generating data defining a part to be built in a direct metal laser sintering. A vertical distance between the print bed and print head, a radial distance between the print head and an axis of rotation, and a degree of rotation between an arm and a defined rotational starting point may be controlled. The vertical distance, radial distance, and the degree of rotation may be defined by a cylindrical coordinate system including a z-coordinate, r-coordinate, and a φ-coordinate. The z-coordinate may define the vertical distance between the print bed and the print head, the r-coordinate may define the radial distance between the print head and the axis of rotation, and the φ-coordinate may define the degree of rotation between the arm and the defined rotational starting point. A print head may be positioned at a starting point above a print bed. The print head may include a nozzle and a laser head. The print head may be positioned on the arm. A first powdered material may be deposited at a first location from a central axis of the print bed. A directed energy source may be used to selectively melt or sinter the first powdered material. The directed energy source may be delivered by the laser head. The r-coordinate may be adjusted. Additional powdered material may be deposited at locations other than the first location. The directed energy source may be used to selectively melt or sinter the additional powdered material. The arm may be rotated. The previous steps may be repeated as necessary in accordance with the data. The z-coordinate may be adjusted. The previous steps may be repeated as necessary in accordance with the data. The part may then be completed.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An additive manufacturing apparatus comprising:
a print bed;
an arm, wherein the arm rotates about a central axis concentric with the print bed;
a print head positioned on the arm, wherein the print head is configured to move relative to the print bed along a cylindrical coordinate system including a z-coordinate, r-coordinate, and a φ-coordinate;
a deposition nozzle disposed on the print head, wherein the deposition nozzle is configured to deposit powdered material onto the print bed; and
a laser head disposed on the print head, wherein the laser head includes a laser.

2. The additive manufacturing apparatus of claim 1, wherein the additive manufacturing apparatus includes a direct metal laser sintering machine.

3. The additive manufacturing apparatus of claim 1, wherein the print bed includes a circular disk shape.

4. The additive manufacturing apparatus of claim 1, wherein the z-coordinate defines a vertical distance between the print bed and the print head, the r-coordinate defines a radial distance between the print head and the axis of rotation, and the φ-coordinate defines a degree of rotation between the arm and a defined rotational starting point.

5. The additive manufacturing apparatus of claim 1, wherein the material includes a powdered metal.

6. The additive manufacturing apparatus of claim 1, wherein the print bed includes a ring shape.

7. The additive manufacturing apparatus of claim 4, wherein the additive manufacturing apparatus is configured to control the vertical distance between the print bed and the print head.

8. The additive manufacturing apparatus of claim 7, wherein the vertical distance between the print bed and the print head is controlled by at least one of a first motor or a first actuator.

9. The additive manufacturing apparatus of claim 4, wherein the additive manufacturing apparatus is configured to control the radial distance between the print head and the axis of rotation.

10. The additive manufacturing apparatus of claim 9, wherein the radial distance between the print head and the axis of rotation is controlled by at least one of a second motor or a second actuator.

11. The additive manufacturing apparatus of claim 4, wherein the additive manufacturing apparatus is configured to control the degree of rotation between the arm and the defined rotational starting point.

12. The additive manufacturing apparatus of claim 11, wherein the degree of rotation between the arm and the defined rotational starting point is controlled by at least one of a first motor or a first actuator.

13. An additive manufacturing method comprising:
(a) generating data defining a part to be built in an additive manufacturing apparatus;
(b) positioning a print head at a starting point above a print bed, wherein the print head includes a deposition nozzle and a laser head, further wherein the print head is positioned on an arm;
(c) depositing a first powdered material at a first location from a central axis of the print bed;
(d) using a directed energy source to selectively melt or sinter the first powdered material, wherein the directed energy source is delivered by the laser head;
(e) moving the print head relative to the print bed in a radial direction from the central axis of the print bed along a cylindrical coordinate system including a z-coordinate, r-coordinate, and a φ-coordinate, wherein the z-coordinate defines a vertical distance between the print bed and the print head, the r-coordinate defines a radial distance between the print head and the axis of rotation, and the φ-coordinate defines a degree of rotation between the arm and a defined rotational starting point;
(f) depositing additional powdered material at locations other than the first location;
(g) using the directed energy source to selectively melt or sinter the additional powdered material;
(h) rotating the arm;
(i) repeating steps (c)-(h) as necessary in accordance with the data;
(j) adjusting the z-coordinate;
(k) repeating steps (c)-(j) as necessary in accordance with the data; and
(l) completing the part.

14. The additive manufacturing method of claim 13 further including building the part with at least a portion of the part including a cylindrical or ring shape.

15. The additive manufacturing apparatus of claim 13 further including controlling the vertical distance between the print bed and the print head.

16. The additive manufacturing apparatus of claim 13 further including controlling the radial distance between the print head and the axis of rotation.

17. The additive manufacturing apparatus of claim 13 further including controlling the degree of rotation between the arm and the defined rotational starting point.

18. The additive manufacturing apparatus of claim 13 further including constructing an internal support structure formed onto the part.

19. The additive manufacturing apparatus of claim 13, wherein moving the print head includes following the data defining the part to guide the print head's motion and deposition of the first and additional powdered material.

20. An additive manufacturing method comprising:
(a) generating data defining a part to be built in a direct metal laser sintering machine;
(b) controlling a vertical distance between a print bed and a print head, a radial distance between the print head and an axis of rotation, and a degree of rotation between an arm and a defined rotational starting point, wherein the vertical distance, radial distance, and the degree of rotation are defined by a cylindrical coordinate system including a z-coordinate, r-coordinate, and a φ-coordinate, wherein the z-coordinate defines the vertical distance between the print bed and the print head, the r-coordinate defines the radial distance between the print head and the axis of rotation, and the (p-coordinate defines the degree of rotation between the arm and the defined rotational starting point;
(c) positioning the print head at a starting point above the print bed, wherein the print head includes a deposition nozzle and a laser head, further wherein the print head is positioned on the arm;
(d) depositing a first powdered material at a first location from a central axis of the print bed;
(e) using a directed energy source to selectively melt or sinter the first powdered material, wherein the directed energy source is delivered by the laser head;
(f) adjusting the r-coordinate;
(g) depositing additional powdered material at locations other than the first location;
(h) using the directed energy source to selectively melt or sinter the additional powdered material;
(i) rotating the arm;
(j) repeating steps (d)-(i) as necessary in accordance with the data;
(k) adjusting the z-coordinate;
(l) repeating steps (d)-(k) as necessary in accordance with the data; and
(m) completing the part.
